(19) United States
(12) Patent Application Publication
(10) Pub. No.: US 2012/0281640 A1
(43) Pub. Date: Nov. 8, 2012

(54) Methods of PDCCH Capacity Enhancement in LTE Systems Based on a TP-Specific Reference Signal

(75) Inventors: Hua Xu, Ottawa (CA); Shiwei Gao, Nepean (CA); Dongsheng Yu, Ottawa (CA); Jack Anthony Smith, Valley View, TX (US)

(73) Assignee: RESEARCH IN MOTION LIMITED, Waterloo (CA)

(21) Appl. No.: 13/198,391

(22) Filed: Aug. 4, 2011

Related U.S. Application Data
(63) Continuation-in-part of application No. 13/169,856, filed on Jun. 27, 2011.
(60) Provisional application No. 61/481,571, filed on May 2, 2011.

(51) Int. Cl. H04W 72/04

(52) U.S. Cl. 370/329

(57) ABSTRACT

A method is provided for providing reference signal information in a cell including a plurality of transmission points in a wireless telecommunication system. The method comprises transmitting, by one of a subset of transmission points in the cell, at least one reference signal for demodulating a PDCCH, wherein transmitting the at least one reference signal comprises transmitting the at least one reference signal in at least one CCE reserved in a PDCCH region for transmission of the at least one reference signal.

### CROSS-REFERENCE TO RELATED APPLICATIONS

This application claims priority to and is a continuation-in-part of U.S. patent application Ser. No. 13/169,856 filed Jun. 27, 2011, by Shiwei Gao, et al, entitled “Methods of PDCCH Capacity Enhancement in LTE Systems” (41960-US-PAT; 4214-32901), which claims priority to U.S. Provisional Patent Application No. 61/481,571, filed May 2, 2011 by Shiwei Gao, et al, entitled “Methods of PDCCH Capacity Enhancement in LTE Systems” (41960-US-PRV; 4214-32900) both of which are incorporated herein by reference as if reproduced in their entirety.

### FIELD OF THE DISCLOSURE

The present disclosure relates to the enhancement of the capacity of the physical downlink control channel in long-term evolution wireless telecommunications systems.

### BACKGROUND

As used herein, the term “user equipment” (alternatively “UE”) might in some cases refer to mobile devices such as mobile telephones, personal digital assistants, handheld or laptop computers, and similar devices that have telecommunications capabilities. Such a UE might include a device and its associated removable memory module, such as but not limited to a Universal Integrated Circuit Card (UICC) that includes a Subscriber Identity Module (SIM) application, a Universal Subscriber Identity Module (USIM) application, or a Removable User Identity Module (R-UIM) application. Alternatively, such a UE might include the device itself without such a module. In other cases, the term “UE” might refer to devices that have similar capabilities but that are not transportable, such as desktop computers, set-top boxes, or network appliances. The term “UE” can also refer to any hardware or software component that can terminate a communication session for a user. Also, the terms “user equipment,” “UE,” “user agent,” “UA,” “user device,” and “mobile device” might be used synonymously herein.

As telecommunications technology has evolved, more advanced network access equipment has been introduced that can provide services that were not possible previously. This network access equipment might include systems and devices that are improvements of the equivalent equipment in a traditional wireless telecommunications system. Such advanced or next generation equipment may be included in evolving wireless communications standards, such as long-term evolution (LTE). For example, an LTE system might include an Evolved Universal Terrestrial Radio Access Network (E-UTRAN) node B (eNB), a wireless access point, or a similar component rather than a traditional base station. Any such component will be referred to herein as an eNB, but it should be understood that such a component is not necessarily an eNB. Such a component may also be referred to herein as an access node.

LTE may be said to correspond to Third Generation Partnership Project (3GPP) Release 8 (Rel-8 or R8), Release 9 (Rel-9 or R9), and Release 10 (Rel-10 or R10), and possibly also to releases beyond Release 10, while LTE Advanced (LTE-A) may be said to correspond to Release 10 and possibly also to releases beyond Release 10. As used herein, the terms “legacy”, “legacy UE”, and the like might refer to signals, UEs, and/or other entities that comply with LTE Release 10 and/or earlier releases but do not comply with releases later than Release 10. The terms “advanced”, “advanced UE”, and the like might refer to signals, UEs, and/or other entities that comply with LTE Release 11 and/or later releases. While the discussion herein deals with LTE systems, the concepts are equally applicable to other wireless systems as well.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a diagram of a downlink LTE subframe, according to the prior art.

FIG. 2 is a diagram of an LTE downlink resource grid, according to the prior art.

FIG. 3 is a diagram of a mapping of a cell-specific reference signal in a resource block in the case of two antenna ports at an eNB, according to the prior art.

FIG. 4 is a diagram of a resource element group allocation in a resource block in the first slot when two antenna ports are configured at an eNB, according to the prior art.

FIG. 5 is a diagram of an example of a remote radio head (RRH) deployment in a cell, according to the prior art.

FIG. 6 is a block diagram of an RRH deployment with a separate central control unit for coordination between a macro-eNB and the RRHs, according to the prior art.

FIG. 7 is a block diagram of an RRH deployment where coordination is done by the macro-eNB, according to the prior art.

FIG. 8 is a diagram of an example of possible transmission schemes in a cell with RRHs, according to an embodiment of the disclosure.

FIG. 9 is a conceptual diagram of the use of selected resource element groups for transmission point-specific reference signal transmission, according to an embodiment of the disclosure.

FIGS. 10a and 10b are conceptual diagrams of configurations of transmission point-specific reference signals using reserved resource element groups, according to an embodiment of the disclosure.

FIG. 11 illustrates a method for providing signaling reference information in a cell in a wireless telecommunication system, according to an embodiment of the disclosure.

FIG. 12 illustrates a processor and related components suitable for implementing the several embodiments of the present disclosure.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The present disclosure deals with cells that include one or more remote radio heads in addition to an eNB. Implementations are provided whereby such cells can take advantage of the capabilities of advanced UEs while still allowing legacy UEs to operate in their traditional manner. More specifically, a transmission point-specific reference signal is introduced that allows a UE to demodulate its control channels without the need of a cell-specific reference signal.

In an LTE system, physical downlink control channels (PDCCHs) are used to carry downlink (DL) or uplink (UL) data scheduling information, or grants, from an eNB to one or more UEs. The scheduling information may include a resource allocation, a modulation and coding rate (or transport block size), the identity of the intended UE or UEs, and other information. A PDCCH could be intended for a single UE, multiple UEs or all UEs in a cell, depending on the nature and content of the scheduled data. A broadcast PDCCH is used to carry scheduling information for a Physical Downlink Shared Channel (PDSCH) that is intended to be received by all UEs in a cell, such as a PDSCH carrying system information about the eNB. A multicast PDCCH is intended to be received by a group of UEs in a cell. A unicast PDCCH is used to carry scheduling information for a PDSCH that is intended to be received by only a single UE.

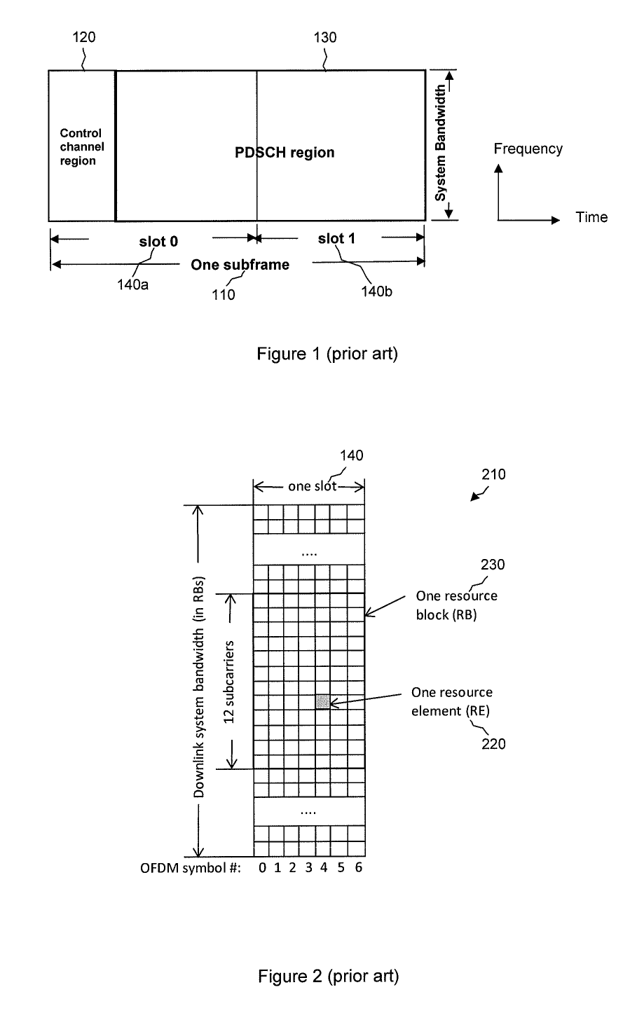

FIG. 1 illustrates a typical DL LTE subframe 110. Control information such as the PCFICH (physical control format indicator channel), PHICH (physical HARQ (hybrid automatic repeat request) indicator channel), and PDCCH are transmitted in a control channel region 120. The control channel region 120 includes the first few OFDM (orthogonal frequency division multiplexing) symbols in the subframe 110. The exact number of OFDM symbols for the control channel region 120 is either dynamically indicated by PCFICH, which is transmitted in the first symbol, or semi-statically configured in the case of carrier aggregation in LTE Rel-10.

The PDSCH, PBCH (physical broadcast channel), PSC/SSC (primary synchronization channel/secondary synchronization channel), and CSI-RS (channel state information reference signal) are transmitted in a PDSCH region 130. DL user data is carried by the PDSCH channels scheduled in the PDSCH region 130. Cell-specific reference signals are transmitted over both the control channel region 120 and the PDSCH region 130, as described in more detail below.

Each subframe 110 can include a number of OFDM symbols in the time domain and a number of subcarriers in the frequency domain. An OFDM symbol in time and a subcarrier in frequency together define a resource element (RE). A physical resource block (RB) can be defined as 12 consecutive subcarriers in the frequency domain and all the OFDM symbols in a slot in the time domain. An RB pair with the same RB index in slot 0 140a and slot 1 140b in a subframe can be allocated together.

FIG. 2 shows an LTE DL resource grid 210 within each slot 140 in the case of a normal cyclic prefix (CP) configuration. The resource grid 210 is defined for each antenna port, i.e., each antenna port has its own separate resource grid 210. Each element in the resource grid 210 for an antenna port is an RE 220, which is uniquely identified by an index pair of a subcarrier and an OFDM symbol in a slot 140. An RB 230 includes a number of consecutive subcarriers in the frequency domain and a number of consecutive OFDM symbols in the time domain, as shown in the figure. An RB 230 is the minimum unit used for the mapping of certain physical channels to REs 220.

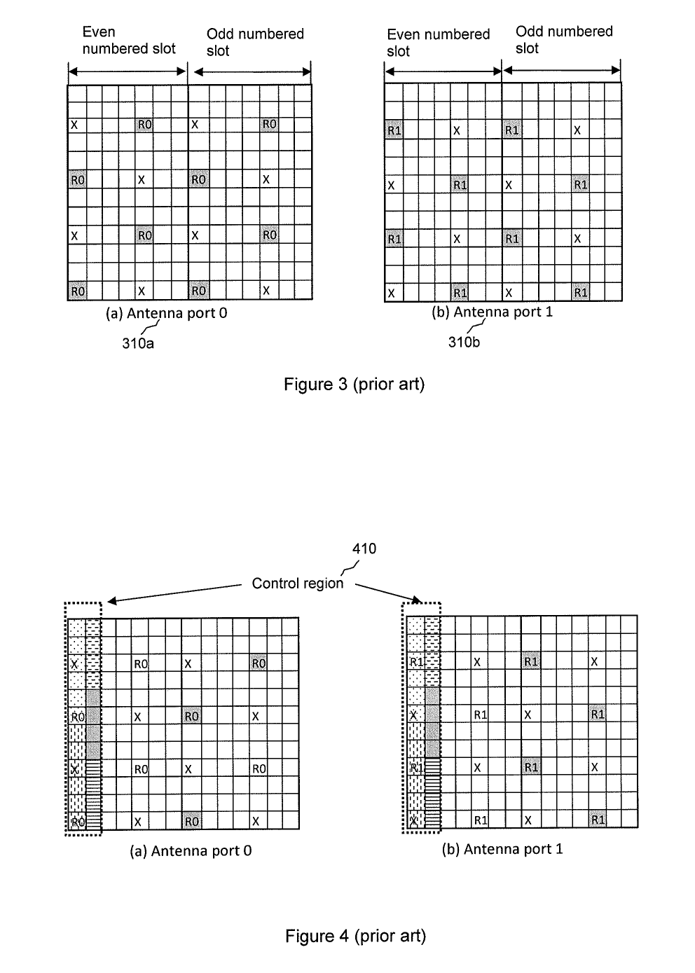

For DL channel estimation and demodulation purposes, cell-specific reference signals (CRSS) can be transmitted over each antenna port on certain predefined time and frequency REs in every subframe. CRSS are used by Rel-8 to Rel-10 legacy UEs to demodulate the control channels. FIG. 3 shows an example of CRS locations in a subframe for two antenna ports 310a and 310b, where the RE locations marked with “R0” and “R1” are used for CRS port 0 and CRS port 1 transmission, respectively. REs marked with “X” indicate that nothing should be transmitted on those REs, as CRSS will be transmitted on the other antenna.

Resource element groups (REGs) are used in LTE for defining the mapping of control channels such as the PDCCH to REs. A REG includes either four or six consecutive REs in an OFDM symbol, depending on the number of CRSs configured. For example, for the two-antenna port CRSs shown in FIG. 3, the REG allocation in each RB is shown in FIG. 4, where the control region 410 includes two OFDM symbols and different REGs are indicated with different types of shading. REs marked with “R0”,“R1” or “X” are reserved for other purposes, and therefore only four REs in each REG are available for carrying control channel data.

A PDCCH is transmitted on an aggregation of one or more consecutive control channel elements (CCEs), where one CCE consists of nine REGs. The CCEs available for a UE's PDCCH transmission are numbered from 0 to n_{CCE}−1. In LTE, multiple formats are supported for the PDCCH as shown in Table 1 below.

TABLE 1

| PDCCH | Number of | Number of resource- | Number of |
|---|---|---|---|
| format | CCEs | element groups | PDCCH bits |
| 0 | 1 | 9 | 72 |
| 1 | 2 | 18 | 144 |
| 2 | 4 | 36 | 288 |
| 3 | 8 | 72 | 576 |

The demand on wireless data services has grown exponentially, driven particularly by the popularity of smart phones. To meet this growing demand, new generations of wireless standards with both multiple input and multiple output (MIMO) and orthogonal frequency division multiple access (OFDMA) and/or single carrier—frequency division multiple access (SC-FDMA) technologies have been adopted in next generation wireless standards such as 3GPP LTE and WIMAX (Worldwide Interoperability for Microwave Access). In these new standards, the peak DL and UL data rates for the whole cell or for a UE can be greatly improved with the MIMO technique, especially when there is a good signal to interference and noise ratio (SINR) at the UE. This is typically achieved when a UE is close to an eNB. Much lower data rates are typically achieved for UEs that are far away from an eNB, i.e., at the cell edge, because of the lower SINR experienced at these UEs due to large propagation losses or high interference levels from adjacent cells, especially in a small cell scenario. Thus, depending on where a UE is located in a cell, different user experiences may be expected by different UEs.

To provide a more consistent user experience, remote radio heads (RRH) with one, two or four antennas may be placed in the areas of a cell where the SINR from the eNB is low to provide better coverage for UEs in those areas. RRHs are sometimes referred to by other names such as remote radio units or remote antennas, and the term “RRH” as used herein should be understood as referring to any distributed radio device that functions as described herein. This type of RRH deployment has been under study in LTE for possible standardization in Release 11 or later releases.

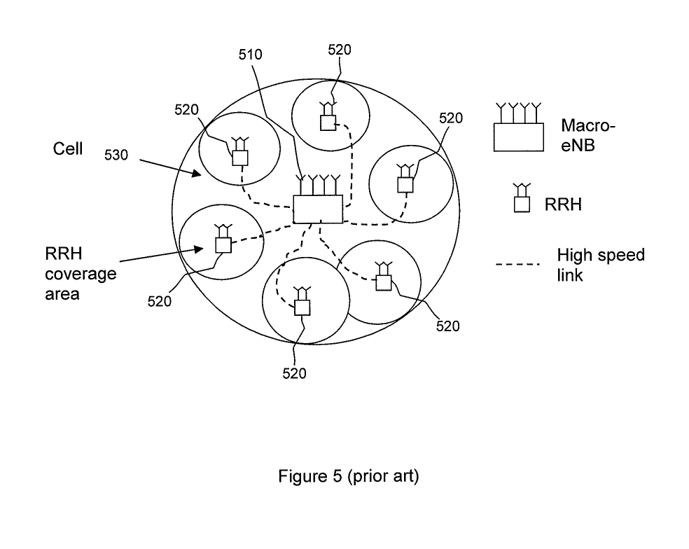

FIG. 5 shows an example of such a deployment with one eNB 510 and six RRHs 520, where the eNB 510 is located near the center of a cell 530 and the six RRHs 520 are spread in the cell 530, such as near the cell edge. An eNB that is deployed with a plurality of RRHs in this manner can be referred to as a macro-eNB. A cell is defined by the coverage of the macro-eNB, which may or may not be located at the center of a cell. The RRHs may or may not be within the coverage of the macro-eNB. In general, the macro-eNB need not always have a collocated radio transceiver and can be considered a device that exchanges data with and controls radio transceivers. The term “transmission point” (TP) may be used herein to refer to either a macro-eNB or an RRH. A macro-eNB or an RRH can be considered a TP with a number of antenna ports.

The RRHs 520 might be connected to the macro-eNB 510 via high capacity and low latency links, such as CPRI (common public radio interface) over optical fiber, to send and receive either digitized baseband signals or radio frequency signals to and from the macro-eNB 510. In addition to coverage enhancement, another benefit of the use of RRHs is an improvement in overall cell capacity. This is especially beneficial in hot-spots, where the UE density may be higher.

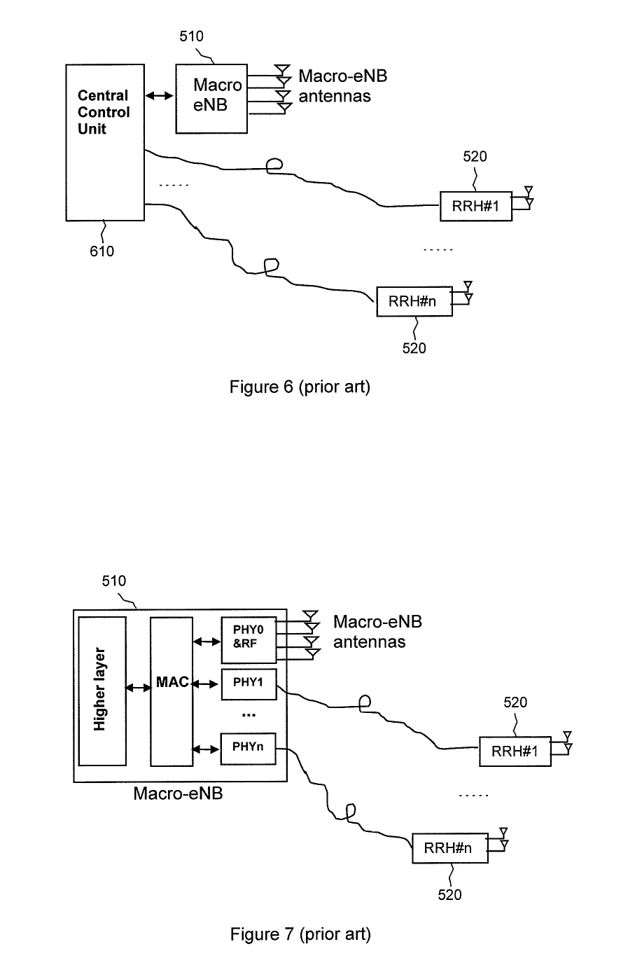

When RRHs are deployed in a cell, there are at least two possible system implementations. In one implementation, as shown in FIG. 6, each RRH 520 may have built-in, full MAC (Medium Access Control) and PHY (Physical) layer functions, but the MAC and the PHY functions of all the RRHs 520 as well as the macro-eNB 510 may be controlled by a central control unit 610. The main function of the central control unit 610 is to perform coordination between the macro-eNB 510 and the RRHs 520 for DL and UL scheduling. In another implementation, as shown in FIG. 7, the functions of the central unit could be built into the macro-eNB 510. In this case, the PHY and MAC functions of each RRH 520 could also be combined into the macro-eNB 510. When the term “macro-eNB” is used hereinafter, it may refer to either a macro-eNB separate from a central control unit or a macro-eNB with built-in central control functions.

In a deployment of one or more RRHs in a cell with a macro-eNB, there are at least two possible operation scenarios. In a first scenario, each RRH is treated as an independent cell and thus has its own cell identifier (ID). From a UE's perspective, each RRH is equivalent to an eNB in this scenario. The normal hand-off procedure is required when a UE moves from one RRH to another RRH. In a second scenario, the RRHs are treated as part of the cell of the macro-eNB. That is, the macro-eNB and the RRHs have the same cell ID. One of the benefits of the second scenario is that the hand-off between the RRHs and the macro-eNB within the cell is transparent to a UE. Another potential benefit is that better coordination may be achieved to avoid interference among the RRHs and the macro-eNB.

These benefits may make the second scenario more desirable. However, some issues may arise regarding differences in how legacy UEs and advanced UEs might receive and use the reference signals that are transmitted in a cell. Specifically, a legacy reference signal known as the cell-specific reference signal (CRS) is broadcast throughout a cell by the macro-eNB and can be used by the UEs for channel estimation and demodulation of control and shared data. The RRHs also transmit a CRS that may be the same as or different from the CRS broadcast by the macro-eNB. Under the first operation scenario, each RRH could transmit a unique CRS that is different from and in addition to the CRS that is broadcast by the macro-eNB. Under the second operation scenario, the macro-eNB and all the RRHs transmit the same CRS.

For the second scenario, where all the RRHs deployed in a cell are assigned the same cell ID as the macro-eNB, several goals may be desirable. First, when a UE is close to one or more TPs, it may be desirable for the DL channels, such as the PDSCH and PDCCH, that are intended for that UE to be transmitted from that TP or those TPs. (Terms such as “close to” or “near” a TP are used herein to indicate that a UE would have a better DL signal strength or quality if the DL signal is transmitted to that UE from that TP rather than from a different TP.) Receiving the DL channels from a nearby TP could result in better DL signal quality at the UE and thus a higher data rate and fewer resources used by the UE. Such transmissions could also result in reduced interference to the neighboring cells.

Second, it may be desirable for the time/frequency resources that are used by a UE served by a TP to be reused for other UEs close to different TPs when the interferences between the TPs are negligible. This would allow for increased spectrum efficiency and thus higher data capacity in the cell.

Third, in the case where a UE sees comparable DL signal levels from a plurality of TPs, it may be desirable for the DL channels intended for the UE to be transmitted jointly from the plurality of TPs in a coordinated fashion to provide a better diversity gain and thus improved signal quality and possibly improved data throughput.

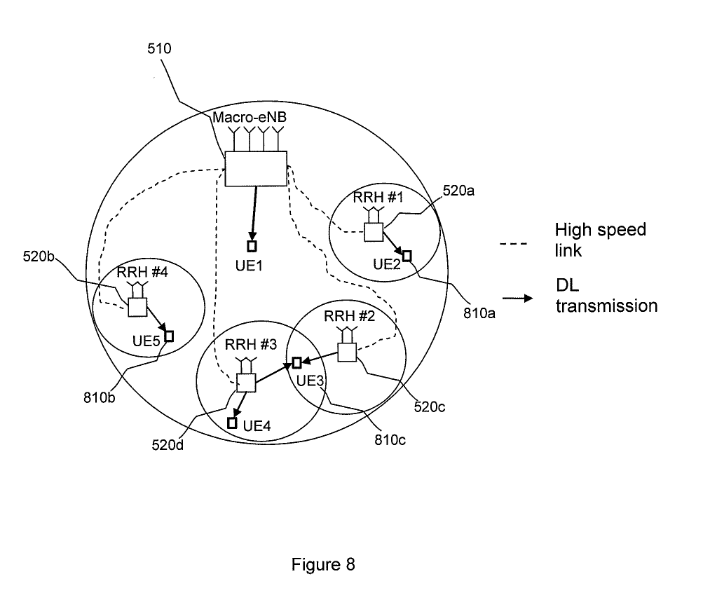

An example of a mixed macro-eNB/RRH cell in which an attempt to achieve these goals might be implemented is illustrated in FIG. 8. It may be desirable for the DL channels for UE2 810a to be transmitted only from RRH#1 520a. Similarly, the DL channels to UE5 810b may be sent only from RRH#4 520b. In addition, it may be allowable for the same time/frequency resources used for UE2 810a to be reused by UE5 810b due to the large spatial separation of RRH #1 520a and RRH #4 520b. Also, it may be desirable for the DL channels for UE3 810c, which is covered by both RRH#2 520c and RRH#3 520d, to be transmitted jointly from both RRH#2 520c and RRH#3 520d such that the signals from the two RRHs 520c and 520d are constructively added at UE3 810c for improved signal quality.

For these goals to be achieved, the UEs 810 may need to be able to measure DL channel state information (CSI) for each individual TP or a set of TPs, depending on a macro-eNB request. For example, the macro-eNB 510 may need to know the DL CSI from RRH#1 520a to UE2 810a in order to transmit DL channels from RRH#1 520a to UE2 810a with proper precoding and proper modulation and coding schemes (MCS). Furthermore, for a joint transmission of a DL channel from RRH#2 520c and RRH#3 520d to UE3 810c, an equivalent four-port DL CSI feedback for the two RRHs 520c and 520d from UE3 810c may be needed. However, these kinds of DL CSI feedback cannot be easily achieved with the Rel-8/9 CRS for one or more of the following reasons.

First, a CRS is transmitted on every subframe and on each antenna port. A CRS antenna port, alternatively referred to as a CRS port, can be defined as the reference signal transmitted on a particular antenna port. Up to four antenna ports are supported, and the number of CRS antenna ports is indicated in the DL PBCH. CRSs are used by UEs in Rel-8/9 for DL CSI measurement and feedback, DL channel demodulation, and link quality monitoring. CRSs are also used by Rel-10 UEs for control channels such as PDCCH/PHICH demodulations and link quality monitoring. Therefore, the number of CRS ports typically needs to be the same for all UEs. Thus, a UE is typically not able to measure and feed back DL channels for a subset of TPs in a cell based on the CRS.

Second, CRSs are used by Rel-8/9 UEs for demodulation of DL channels in certain transmission modes. Therefore, DL signals typically need to be transmitted on the same set of antenna ports as the CRS in these transmission modes. This implies that DL signals for Rel-8/9 UEs may need to be transmitted on the same set of antenna ports as the CRS.

Third, CRSs are also used by Rel-8/9/10 UEs for DL control channel demodulations. Thus, the control channels typically have to be transmitted on the same antenna ports as the CRS.

In Rel-10, channel state information reference signals (CSI-RS) are introduced for DL CSI measurement and feedback by Rel-10 UEs. CSI-RS is cell-specific in the sense that a single set of CSI-RS is transmitted in each cell. Muting is also introduced in Rel-10, in which the REs of a cell's PDSCH are not transmitted so that a UE can measure the DL CSI from neighbor cells.

In addition, UE-specific demodulation reference signals (DMRS) are introduced in the DL in Rel-10 for PDSCH demodulation without a CRS. With the DL DMRS, a UE can demodulate a DL data channel without knowledge of the antenna ports or the precoding matrix being used by the eNB for the transmission. A precoding matrix allows a signal to be transmitted over multiple antenna ports with different phase shifts and amplitudes.

Therefore, CRS reference signals are no longer required for a Rel-10 UE to perform CSI feedback and data demodulation. However, CRS reference signals are still required for control channel demodulation. This means that, even for a UE-specific or unicast PDCCH, the PDCCH has to be transmitted on the same antenna ports as the CRS. Therefore, with the current PDCCH design, a PDCCH cannot be transmitted from only a TP close to a UE. Thus, it is not possible to reuse the time and frequency resources for the PDCCH.

Thus, at least three problems with the existing CRS have been identified. First, the CRS cannot be used for PDCCH demodulation if a PDCCH is transmitted from antenna ports that are different from the CRS ports. Second, the CRS is not adequate for CSI feedback of individual TP information when data transmissions to a UE are desired on a TP-specific basis for capacity enhancement. Third, the CRS is not adequate for joint CSI feedback for a group of TPs for joint PDSCH transmission.

To restate the issues, in a first scenario, different IDs are used for the macro-eNB and the RRHs, and in a second scenario, the macro-eNB and the RRHs have the same ID. If the first scenario is deployed, the benefits of the second scenario described above could not be easily gained due to possible CRS and control channel interference between the macro-eNB and the RRHs. If these benefits are desired and the second scenario is selected, some accommodations may need to be made for the differences between the capabilities of legacy UEs and advanced UEs. A legacy UE performs channel estimation based on CRSs for DL control channel (PDCCH) demodulation. A PDCCH intended for a legacy UE may need to be transmitted on the same TPs over which the CRSs are transmitted. Since CRSs are transmitted over all TPs, the PDCCH may also need to be transmitted over all the TPs. A Rel-8 or Rel-9 UE also depends on CRSs for PDSCH demodulation. Thus, a PDSCH for the UE may need to be transmitted on the same TPs as the CRSs. Although Rel-10 UEs do not depend on CRSs for PDSCH demodulation, they may have difficulty in measuring and feeding back DL CSI for each individual TP, which may be required for an eNB to send the PDSCH over only the TPs close to the UEs. An advanced UE may not depend on a CRS for PDCCH demodulation. Thus, the PDCCH for such a UE might be transmitted over only the TPs close to the UE. In addition, an advanced UE is able to measure and feed back DL CSI for each individual TP. Such capabilities of advanced UEs provide possibilities for cell operation that are not available with legacy UEs.

As an example, two advanced UEs that are widely separated in a cell may each be near an RRH, and the coverage areas of the two RRHs may not overlap. Each UE might receive a PDCCH or PDSCH from its nearby RRH. Since each UE could demodulate its PDCCH or PDSCH without a CRS, each UE could receive its PDCCH and PDSCH from its nearby RRH rather than from the macro-eNB. Since the two RRHs are widely separated, the same PDCCH and PDSCH time/frequency resources could be reused in the two RRHs, thus improving the overall cell spectrum efficiency. Such cell operation is not possible with legacy UEs.

As another example, a single advanced UE might be located in an area of overlapping coverage by two RRHs and could receive and properly process CRSs from each RRH. This would allow the advanced UE to communicate with both of the RRHs, and signal quality at the UE could be improved by constructive addition of the signals from the two RRHs.

Embodiments of the present disclosure deal with the second operation scenario where the macro-eNB and the RRHs have the same cell ID. Therefore, these embodiments can provide the benefits of transparent hand-offs and improved coordination that are available under the second scenario.

U.S. patent application Ser. No. 13/169,856, filed Jun. 27, 2011 by Shiwei Gao, et al., entitled “Method of PDCCH Capacity Enhancement in LTE Systems”, which is incorporated by reference herein as if reproduced in its entirety, discloses systems and methods for addressing the above described issues. In that application, a PDCCH intended for a specific advanced UE is allocated in the control channel region in the same way a legacy PDCCH is allocated, but for each REG allocated to the UE-specific PDCCH for an advanced UE, one or more of the REs not allocated for the CRS are replaced with a UE-specific DMRS symbol. The UE-specific DMRS is a sequence of complex symbols carrying a UE-specific bit sequence, and thus only the intended UE is able to decode the PDCCH correctly.

In the solution discussed in the above-cited patent application, the overall PDCCH capacity can be increased in a cell with multiple TPs sharing the same cell ID due to PDCCH resource reuse in different TPs. However, in some cases, that solution could result in an increase in the UE-specific DMRS overhead, which could, in some cases, decrease the PDCCH capacity in each individual TP.

In an embodiment, to prevent this potential increase in overhead, TP-specific PDCCH reference signals are introduced, where a common set of reference signals are transmitted on the REGs of some reserved CCEs within the legacy PDCCH region. That is, one or more CCEs in the legacy PDCCH region are reserved for reference signals that are transmitted by a subset of the TPs in a cell. Advanced UEs that receive such a reference signal can use the signal to demodulate the PDCCH. Legacy UEs will not recognize the reference signals in these CCEs and will simply move on to the next PDCCH candidate and attempt to demodulate the PDCCH using the CRS as in the legacy case.

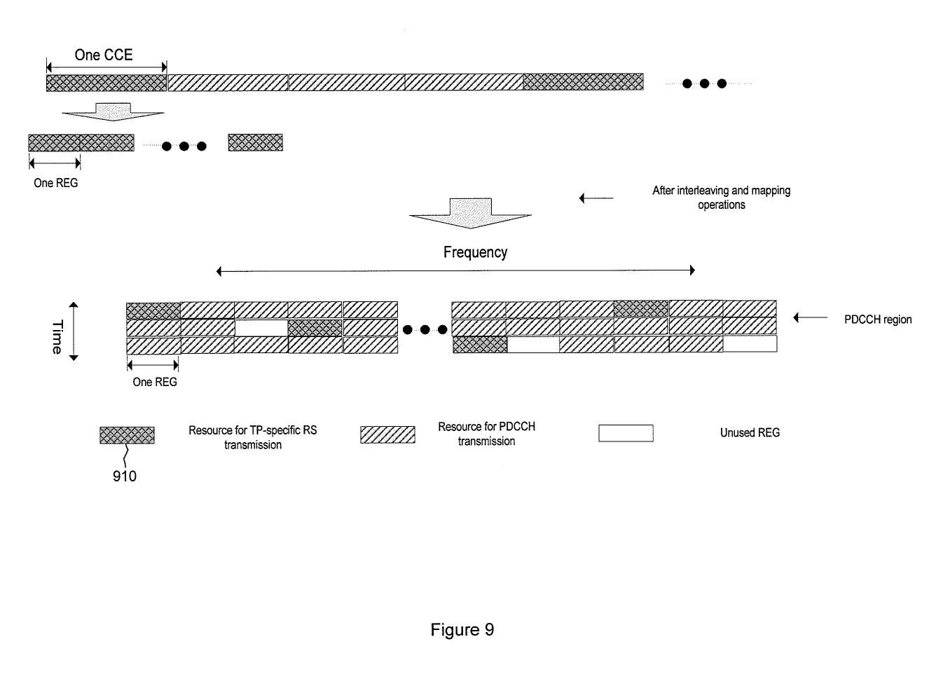

Such an embodiment is shown in FIG. 9, where certain resources 910 within certain CCEs are selected for TP-specific reference signal transmission. The criterion used for the selection of such CCEs could be that, after resource mapping to the PDCCH region, the REGs within the selected CCEs are spread evenly in time and/or frequency in the PDCCH region. Such spreading would lead to good channel estimation performance.

In one embodiment, all the REs in a REG in the selected CCEs are reserved for TP-specific reference signal transmission and are not used for any PDCCH transmission. In another embodiment, only a subset of the REs in a REG in the selected CCEs are used for TP-specific reference signal transmission. The remaining REs can be used for PDCCH transmission. In another embodiment, only a subset of the REGs in the selected CCEs are used for TP-specific reference signal transmission. The remaining REGs can be used for PDCCH transmission. If a PDCCH is assigned in these CCEs, the REs or REGs reserved for the TP-specific reference signal will be skipped and an approach similar to one or more approaches discussed in the above-cited patent application could be used for the processing of the PDCCH.

The selection of CCEs for a TP-specific reference signal could be pre-defined and could depend on the system bandwidth and/or the number of OFDM symbols in the PDCCH region. That is, for each particular PDCCH region, a selected set of CCEs for TP-specific reference signals could be pre-defined based on system bandwidth and/or number of OFDM symbols. Such a selection could guarantee a sufficient density of reference signals in the PDCCH region in both time and frequency domains. After time-frequency mapping of the PDCCH is complete, the locations of the REGs from these CCEs would be spread in the PDCCH region. Legacy UEs will simply fail to decode the PDCCH on these CCEs and will not be aware that such CCEs are being used for TP-specific reference signal transmission. Advanced UEs that support such operation would know the locations of such CCEs and the corresponding REGs and would be aware of the transmission of TP-specific reference signals over these REGs. Advanced UEs could conduct channel estimation based on the reference signals transmitted on each of these REGs and could improve channel estimation performance by performing interpolation among estimated channels from the reference signals transmitted on these REGs.

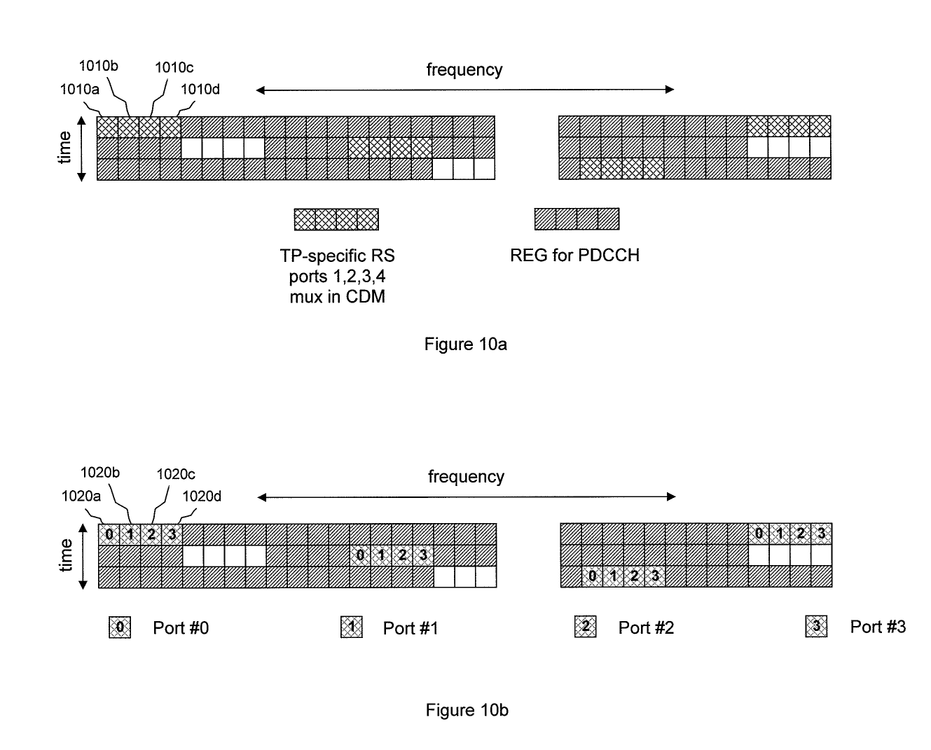

As one REG contains four REs, each RE could be used to transmit different antenna ports for a TP in either a code division multiplexing (CDM) fashion or a frequency division multiplexing (FDM) fashion. FIGS. 10a and 10b illustrate two alternatives as examples. In the first alternative, shown in FIG. 10a, multiple antenna ports for TP-specific reference signals are multiplexed in a CDM fashion. Namely, each antenna port transmits on all four REs 1010 in a REG, and the REs 1010 are modulated with different orthogonal codes such as Walsh codes. In the second alternative, shown in FIG. 10b, multiple antenna ports for TP-specific reference signals are multiplexed in a FDM fashion. Namely, each antenna port transmits on separate REs 1020 in a REG.

In another alternative, the reference signals from different TPs are multiplexed in an FDM/CDM fashion. For example, the first two REs in a REG could be used to transmit a reference signal from one TP, while the remaining two REs in that REG could be used to transmit a reference signal from another TP. Alternatively, all four REs in each REG could be used to transmit reference signals from two TPs, each with two antenna ports. These reference signals could be multiplexed in a CDM manner using different orthogonal codes. Such multiplexing would make the reference signals from different TPs orthogonal to each other and would therefore facilitate joint transmission in an overlapping region of two TPs.

A benefit of such transmissions of TP-specific reference signals is that they can introduce a reference signal for a particular TP or subset of TPs without interfering with the operation of the legacy CRS and legacy PDCCH transmissions that may be transmitted from all TPs (including the macro-eNB) within a coverage area. This maintains support for legacy UEs that use the legacy CRS to demodulate the legacy PDCCH, while also providing a reference signal for advanced UEs to demodulate PDCCH transmissions from only a single TP or a subset of TPs.

Another benefit of using a reserved CCE for TP-specific reference signal transmission is that it may not introduce too much overhead and may not cause degradation in PDCCH demodulation performance. This is because of the way that multiple PDCCHs are multiplexed in the legacy PDCCH region, often leaving some CCEs in the PDCCH region that are not used for any transmission. Using at least one CCE (and at least one of its REGs) for a TP-specific reference signal transmission utilizes some of the CCEs without sacrificing the overall PDCCH performance, since a UE would in any case skip any CCEs that are occupied by another PDCCH.

The use of reserved CCEs for TP-specific reference signal transmission will have no impact to legacy UEs in decoding the legacy PDCCH, as they will simply use the CRS for PDCCH demodulation. Legacy UEs will try to decode the PDCCH on such CCEs if the CCEs fall into the potential PDCCH candidate regions for those UEs. After failing to decode the PDCCH, the legacy UEs will simply move on to the next PDCCH candidate, as if such CCEs are occupied by other PDCCHs. An advanced UE can use the TP-specific reference signals transmitted on these CCEs to improve its channel estimation and decode a TP-specific PDCCH intended for that UE.

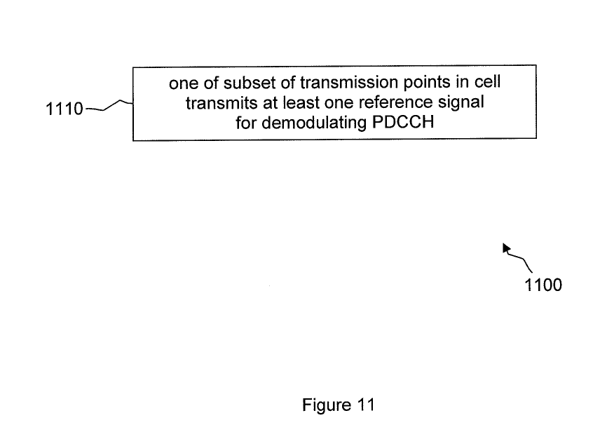

FIG. 11 illustrates an embodiment of a method 1100 for providing reference signal information in a cell including a plurality of transmission points in a wireless telecommunication system. At block 1110, one of a subset of transmission points in the cell transmits at least one reference signal for demodulating a PDCCH. Transmitting the at least one reference signal comprises transmitting the at least one reference signal in at least one CCE reserved in a PDCCH region for transmission of the at least one reference signal. The PDCCH region might be the PDCCH region as defined in past, current, or future LTE standards. The at least one CCE in the PDCCH region was previously selected for TP-specific reference signal transmissions. Such reserved CCEs could be pre-determined and known to advanced UEs. The number of reserved CCEs for TP-specific reference signal transmission could depend on the system bandwidth and/or the number of OFDM symbols in the PDCCH region. The antenna ports from one TP or multiple TPs could be multiplexed on each REG in these CCEs in FDM or CDM fashions. Advanced UEs could rely on a TP-specific reference signal to demodulate their PDCCH received from one TP or multiple TPs, while legacy UEs could still rely on the CRS for PDCCH demodulation.

These embodiments allow a unicast PDCCH to be transmitted from a TP close to a UE such that better PDCCH signal quality is achieved at the UE. Fewer PDCCH resources are needed with a low aggregation level as the UE is close to the TP. In addition, higher order modulation may be supported for a PDCCH to further reduce resources used by the PDCCH so that more PDCCHs (and thus UEs) may be supported in a subframe. Further, the same PDCCH resources may be reused for a UE in a different TP for further PDCCH capacity improvement in a cell. The embodiments are backward compatible with legacy UEs.

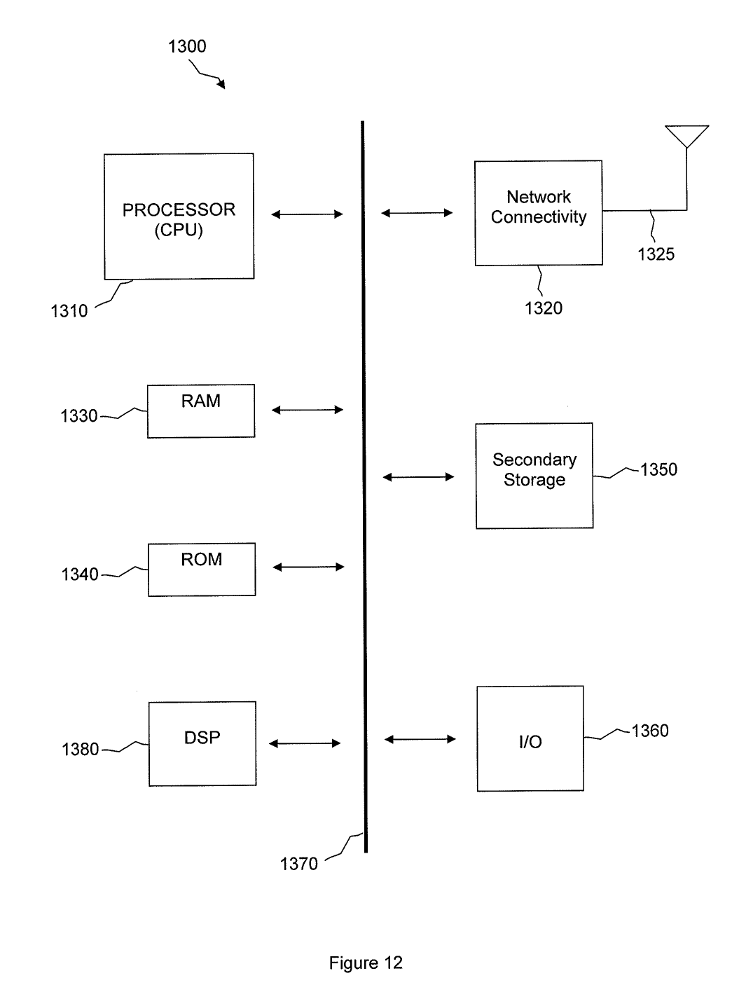

The UE and other components described above might include a processing component that is capable of executing instructions related to the actions described above. FIG. 12 illustrates an example of a system 1300 that includes a processing component 1310 suitable for implementing one or more embodiments disclosed herein. In addition to the processor 1310 (which may be referred to as a central processor unit or CPU), the system 1300 might include network connectivity devices 1320, random access memory (RAM) 1330, read only memory (ROM) 1340, secondary storage 1350, and input/output (I/O) devices 1360. These components might communicate with one another via a bus 1370. In some cases, some of these components may not be present or may be combined in various combinations with one another or with other components not shown. These components might be located in a single physical entity or in more than one physical entity. Any actions described herein as being taken by the processor 1310 might be taken by the processor 1310 alone or by the processor 1310 in conjunction with one or more components shown or not shown in the drawing, such as a digital signal processor (DSP) 1380. Although the DSP 1380 is shown as a separate component, the DSP 1380 might be incorporated into the processor 1310.

The processor 1310 executes instructions, codes, computer programs, or scripts that it might access from the network connectivity devices 1320, RAM 1330, ROM 1340, or secondary storage 1350 (which might include various disk-based systems such as hard disk, floppy disk, or optical disk). While only one CPU 1310 is shown, multiple processors may be present. Thus, while instructions may be discussed as being executed by a processor, the instructions may be executed simultaneously, serially, or otherwise by one or multiple processors. The processor 1310 may be implemented as one or more CPU chips.

The network connectivity devices 1320 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, universal mobile telecommunications system (UMTS) radio transceiver devices, long term evolution (LTE) radio transceiver devices, worldwide interoperability for microwave access (WiMAX) devices, and/or other well-known devices for connecting to networks. These network connectivity devices 1320 may enable the processor 1310 to communicate with the Internet or one or more telecommunications networks or other networks from which the processor 1310 might receive information or to which the processor 1310 might output information. The network connectivity devices 1320 might also include one or more transceiver components 1325 capable of transmitting and/or receiving data wirelessly.

The RAM 1330 might be used to store volatile data and perhaps to store instructions that are executed by the processor 1310. The ROM 1340 is a non-volatile memory device that typically has a smaller memory capacity than the memory capacity of the secondary storage 1350. ROM 1340 might be used to store instructions and perhaps data that are read during execution of the instructions. Access to both RAM 1330 and ROM 1340 is typically faster than to secondary storage 1350. The secondary storage 1350 is typically comprised of one or more disk drives or tape drives and might be used for non-volatile storage of data or as an over-flow data storage device if RAM 1330 is not large enough to hold all working data. Secondary storage 1350 may be used to store programs that are loaded into RAM 1330 when such programs are selected for execution.

The I/O devices 1360 may include liquid crystal displays (LCDs), touch screen displays, keyboards, keypads, switches, dials, mice, track balls, voice recognizers, card readers, paper tape readers, printers, video monitors, or other well-known input/output devices. Also, the transceiver 1325 might be considered to be a component of the I/O devices 1360 instead of or in addition to being a component of the network connectivity devices 1320.

In an embodiment, a method is provided for providing reference signal information in a cell including a plurality of transmission points in a wireless telecommunication system. The method comprises transmitting, by one of a subset of transmission points in the cell, at least one reference signal for demodulating a PDCCH, wherein transmitting the at least one reference signal comprises transmitting the at least one reference signal in at least one CCE reserved in a PDCCH region for transmission of the at least one reference signal.

In another embodiment, a transmission point in a cell in a wireless telecommunication system is provided. The transmission point comprises a processor configured such that the transmission point transmits at least one reference signal for demodulating a PDCCH, wherein the transmission point transmits the at least one reference signal in at least one CCE reserved in a PDCCH region for transmission of the at least one reference signal.

In another embodiment, a UE is provided. The UE includes a processor configured such that the UE receives at least one reference signal for demodulating a PDCCH, wherein the at least one reference signal is received in at least one CCE reserved in a PDCCH region for transmission of the at least one reference signal.

The following are incorporated herein by reference for all purposes: 3GPP Technical Specification (TS) 36.211 and 3GPP TS 36.213.

While several embodiments have been provided in the present disclosure, it should be understood that the disclosed systems and methods may be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for providing reference signal information in a cell including a plurality of transmission points in a wireless telecommunication system, the method comprising:
transmitting, by one of a subset of transmission points in the cell, at least one reference signal for demodulating a physical downlink control channel (PDCCH), wherein transmitting the at least one reference signal comprises transmitting the at least one reference signal in at least one control channel element (CCE) reserved in a PDCCH region for transmission of the at least one reference signal.

2. The method of claim 1, wherein the at least one CCE is selected such that, after resource mapping to the PDCCH region, resource element groups in the at least one CCE are spread substantially evenly in the PDCCH region in time, in frequency, or in both time and frequency.

3. The method of claim 2, wherein selection of the at least one CCE is based on at least one of:
a system bandwidth;
a number of orthogonal frequency division multiplexing symbols in the PDCCH region; and
a number of resource blocks reserved for transmitting the PDCCH.

4. The method of claim 2, wherein the selected at least one CCE is known to the subset of transmission points and to at least one user equipment to which the subset of transmission points transmits the at least one CCE.

5. The method of claim 1, wherein all resource elements in a resource element group in the at least one CCE are reserved for the at least one reference signal and none of the resource elements in the resource element group are used for PDCCH transmission.

6. The method of claim 1, wherein a subset of resource elements in a resource element group in the at least one CCE are reserved for the at least one reference signal and the remaining resource elements in the resource element group are available for PDCCH transmission.

7. The method of claim 1, wherein a subset of resource element groups in the at least one CCE are reserved for the at least one reference signal and the remaining resource element groups are available for PDCCH transmission.

8. The method of claim 1, wherein at least one reference signal is transmitted from a single transmission point on each of four resource elements in a resource element group in the at least one CCE, the reference signals on the resource elements being multiplexed in at least one of:
a code division multiplexing fashion; and
a frequency division multiplexing fashion.

9. The method of claim 1, wherein a first reference signal from a first transmission point is transmitted on a first portion of resource elements in a resource element group in the at least one CCE and a second reference signal from a second transmission point is transmitted on a second portion of resource elements in the resource element group.

10. The method of claim 1, wherein at least two reference signals, each from a different transmission point, are transmitted on each of four resource elements in a resource element group in the at least one CCE, the reference signals on the resource elements being multiplexed in a code division multiplexing fashion.

11. The method of claim 1, wherein the at least one reference signal is different from a reference signal transmitted by at least one other transmission point in the cell.

12. The method of claim 1, wherein resources used for transmitting the at least one reference signal are reused by at least one other transmission point in the cell.

13. A transmission point in a cell in a wireless telecommunication system, the transmission point comprising:
a processor configured such that the transmission point transmits at least one reference signal for demodulating a physical downlink control channel (PDCCH), wherein the transmission point transmits the at least one reference signal in at least one control channel element (CCE) reserved in a PDCCH region for transmission of the at least one reference signal.

14. The transmission point of claim 13, wherein the at least one CCE is selected such that, after resource mapping to the PDCCH region, resource element groups in the at least one CCE are spread substantially evenly in the PDCCH region in time, in frequency, or in both time and frequency.

15. The transmission point of claim 14, wherein selection of the at least one CCE is based on at least one of:
a system bandwidth;
a number of orthogonal frequency division multiplexing symbols in the PDCCH region; and
a number of resource blocks reserved for transmitting the PDCCH.

16. The transmission point of claim 14, wherein the selected at least one CCE is known to the transmission point and to at least one user equipment to which the transmission point transmits the at least one CCE.

17. The transmission point of claim 13, wherein all resource elements in a resource element group in the at least one CCE are reserved for the at least one reference signal and none of the resource elements in the resource element group are used for PDCCH transmission.

18. The transmission point of claim 13, wherein a subset of resource elements in a resource element group in the at least one CCE are reserved for the at least one reference signal and the remaining resource elements in the resource element group are available for PDCCH transmission.

19. The transmission point of claim 13, wherein a subset of resource element groups in the at least one CCE are reserved for the at least one reference signal and the remaining resource element groups are available for PDCCH transmission.

20. The transmission point of claim 13, wherein the transmission point transmits at least one reference signal on each of four resource elements in a resource element group in the at least one CCE, the reference signals on the resource elements being multiplexed in at least one of:
a code division multiplexing fashion; and
a frequency division multiplexing fashion.

21. The transmission point of claim 13, wherein the transmission point transmits a first reference signal on a first portion of resource elements in a resource element group in the at least one CCE and a second reference signal from a second transmission point is transmitted on a second portion of resource elements in the resource element group.

22. The transmission point of claim 13, wherein at least two reference signals, at least one from the transmission point and at least one from a different transmission point, are transmitted on each of four resource elements in a resource element group in the at least one CCE, the reference signals on the resource elements being multiplexed in a code division multiplexing fashion.

23. The transmission point of claim 13, wherein the at least one reference signal is different from a reference signal transmitted by at least one other transmission point in the cell.

24. The transmission point of claim 13, wherein resources used for transmitting the at least one reference signal are reused by at least one other transmission point in the cell.

25. The transmission point of claim 13, wherein the transmission point is a remote radio head.

26. A user equipment (UE), comprising:
a processor configured such that the UE receives at least one reference signal for demodulating a physical downlink control channel (PDCCH), wherein the at least one reference signal is received in at least one control channel element (CCE) reserved in a PDCCH region for transmission of the at least one reference signal.

27. The UE of claim 26, wherein the at least one CCE is known to the UE through higher layer signaling.

28. The UE of claim 26, wherein the at least one reference signal received by the UE is carried in at least one resource element of at least one resource element group of the at least one CCE.

29. The UE of claim 26, wherein the at least one reference signal received by the UE is carried in each of four resource elements in a resource element group in the at least one CCE, the reference signals on the resource elements having been multiplexed in at least one of:
a code division multiplexing fashion; and
a frequency division multiplexing fashion.

30. The UE of claim 26, wherein UE receives at least two reference signals, each from a different transmission point, and wherein the at least two reference signals are transmitted on each of four resource elements in a resource element group in the at least one CCE, the reference signals on the resource elements being multiplexed in a code division multiplexing fashion.

31. The UE of claim 26, wherein the UE performs channel estimation based on the at least one reference signal.
